(19) United States
(12) Patent Application Publication
(10) Pub. No.: US 2007/0210775 A1
(43) Pub. Date: Sep. 13, 2007

(54) Power supply integration for low power single chip RF CMOS solutions for use in battery operated electronic devices

(75) Inventors: Subhas Bothra, Fremont, CA (US); Louis Pandula, Sunnyvale, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/369,976

(22) Filed: Mar. 8, 2006

(51) Int. Cl. G05F 1/00

(52) U.S. Cl. 323/283

(57) ABSTRACT

An integrated circuit power supply includes a DC-to-DC converter and a low drop-out voltage regulator. The DC-to-DC converter efficiently performs voltage conversion and provides power to the low-dropout voltage regulator. The low-dropout voltage regulator rejects noise and regulates an output voltage. The combination of the DC-to-DC converter and a low-dropout voltage regulator provides high-efficiency voltage conversion and noise rejection.

### FIELD OF THE INVENTION

This invention relates generally to power supplies and specifically to power supply integration for low-power single chip RF CMOS solutions.

### BACKGROUND OF THE INVENTION

### Background Art

Battery-operated electronics typically contain circuits that require different supply voltages. Battery voltage is typically changed to meet supply voltage requirements of a phase-locked loop with either voltage regulators or direct-current to direct-current (DC-to-DC) converters.

FIG. 1 shows a voltage regulator 100. The voltage regulator converts an input voltage (Vin) 102 to a lower output voltage (Vout) 104 and diverts some energy to ground 106 in the process. The voltage regulator 100 maintains a constant output voltage 104 by use of a negative feedback loop. The negative feedback loop compares the output voltage 104 to an internal reference and generates an error signal that controls an electron valve to vary the output voltage 104. The voltage regulator 100 has an input current (Iin) 108 that is equal to an output current (Iout) 110 plus a regulator current (Ireg) 112 where the regulator current 112 flows to ground 106. The efficiency for the voltage regulator 100 is given by the equation: Efficiency=(Vout 104·Iout 110)/(Vin 102·Iin 108).

Voltage regulator 100 use with a battery 114 in a battery-powered device is inefficient. For example, if Vin=3.3 vdc, Vout=1.8 vdc, and Ireg<<<Iout so that Iout≈Iin, then maximum voltage regulator efficiency=54.5%. Thus, in a battery-powered device, excess energy is wasted as heat and tends to drain a battery 114 at a quick rate.

As illustrated in FIG. 2, DC-to-DC converters 200 are also used to convert voltages in a battery-powered device. However, DC-to-DC converters 200 add noise at their switching frequency, which is usually >200 Khz, and also at low frequencies, for example, below 30 KHz. In circuits such as a phase-locked loop (PLL) 202, switching frequency noise originating from the DC-to-DC converter 200 can be filtered in the PLL 202 by keeping PLL 202 loop bandwidth greater than the DC-to-DC converter 200 switching frequency. The PLL 202 typically has a loop bandwidth of >100 KHz. However, low frequency noise added by the DC-to-DC converters 200 can be within the loop bandwidth of the PLL 202. Therefore, PLL 202 performance suffers because the PLL 202 does not reject the low frequency noise added by the DC-to-DC converters 200. The addition of noise rejection circuitry to the PLL 202 leads to increased manufacturing and design costs.

Accordingly, what is needed is an invention that overcomes the shortcomings noted above.

### BRIEF SUMMARY OF THE INVENTION

A method and apparatus for converting and regulating DC power at high-efficiency with low noise. Power is supplied to a DC-to-DC converter, the output of which feeds a low-dropout voltage regulator. A DC-to-DC converter efficiently performs voltage conversion while a low-dropout voltage regulator rejects noise and regulates an output voltage.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention. The present invention is described with reference to the accompanying drawings. In the drawings, like reference numbers indicate identical or functionally similar elements. Additionally, the left-most digit(s) of a reference number identifies the drawing in which the reference number first appears.

In the drawings:

FIG. 1 shows a conventional battery and voltage regulator circuit;

FIG. 2 shows a conventional DC-to-DC converter and phase-locked loop circuit;

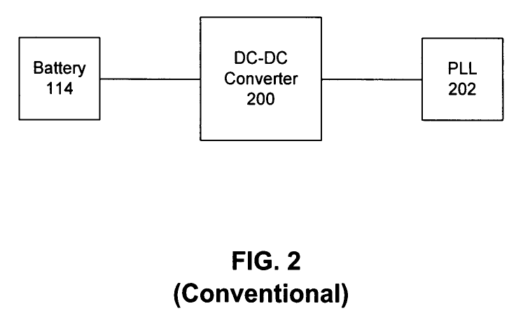

FIG. 3A illustrates one embodiment of the invention with a DC-to-DC converter, a voltage regulator, and a phase-locked loop;

FIG. 3B illustrates one embodiment of the invention with a DC-to-DC converter and a plurality of voltage regulators;

FIG. 4 illustrates a flowchart of operation of one embodiment of the invention; and

FIG. 5 illustrates one embodiment of the invention with a DC-to-DC converter, a voltage regulator, and a low-pass filter.

### DETAILED DESCRIPTION OF THE INVENTION

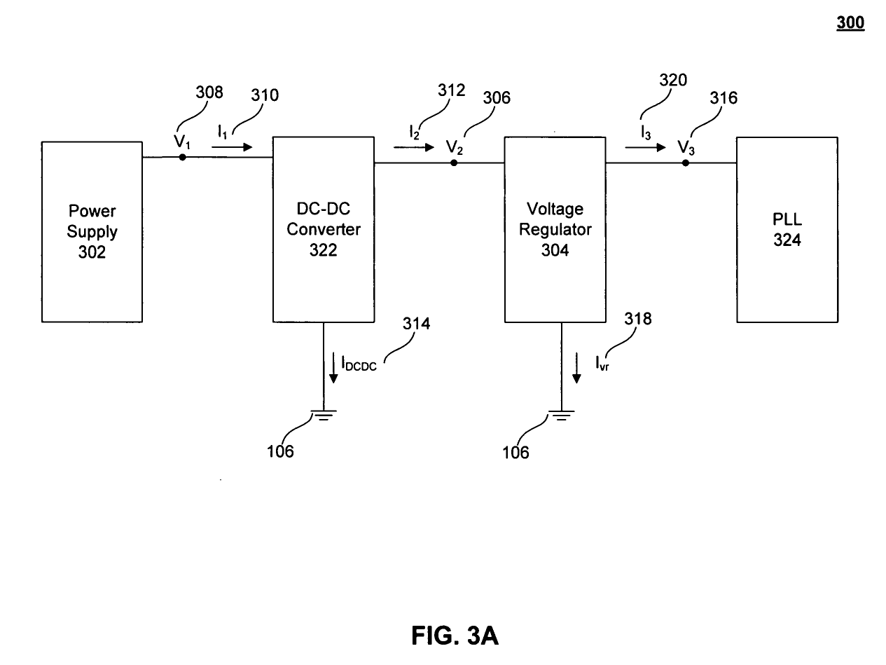

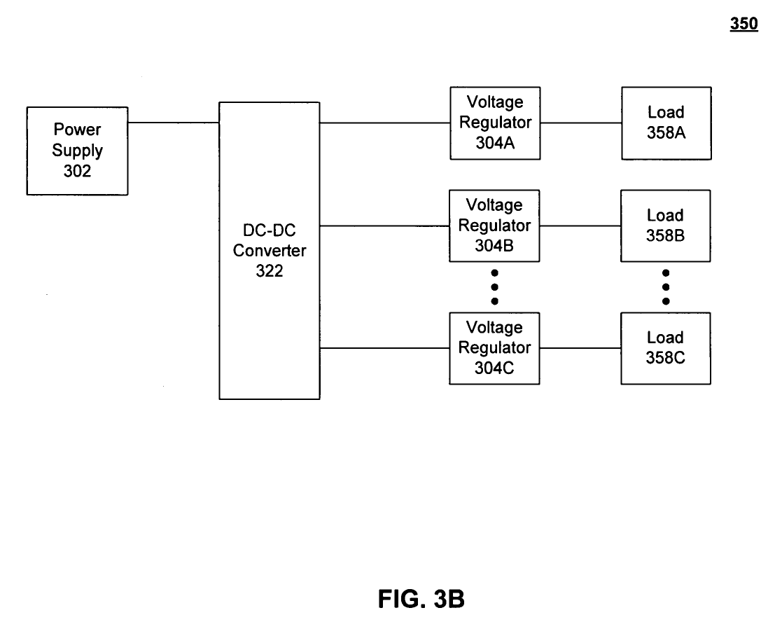

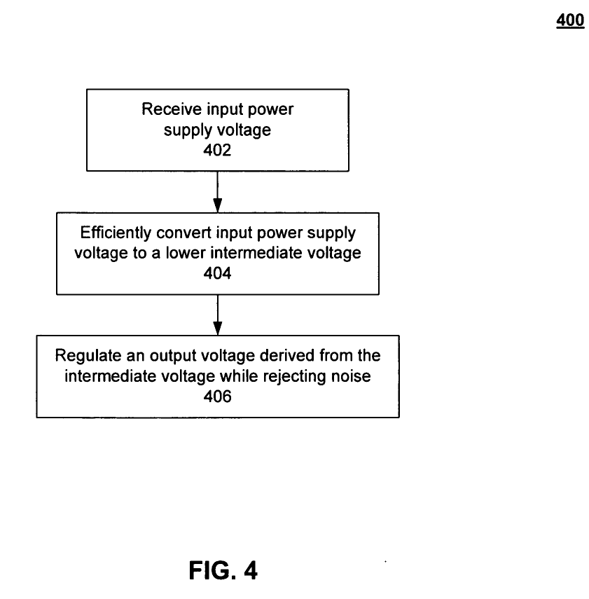

Embodiments of the present invention provide a method and apparatus for power supply integration for low-power single chip RF CMOS circuits. FIGS. 3 and 4, described below, illustrate this approach.

Exemplary Structure

FIG. 3A illustrates a power integration system 300, which is one embodiment of the invention. The power integration system 300 includes a power supply 302, a DC-DC converter 322, a low-dropout voltage regulator 304, and a phase-locked loop (PLL) 324. As discussed below, the power integration system 300 provides an efficient, low drop-out, low noise, voltage supply with output voltage (V₃) 316 and output current (I₃) 320 for use by a PLL 324 or any other load.

Referring to FIG. 3A, a power supply 302 is coupled to an input of a high-efficiency DC-to-DC converter 322. In one example, a power supply 302 is a battery 114. In another example, a power supply 302 is a DC power source.

A DC-to-DC converter 322 is used to convert an input DC voltage to an output DC voltage that is different from the input DC voltage. Thus, DC-to-DC converters are used to step-up or step-down a DC voltage. An output DC voltage of a DC-to-DC converter 322 may be lower than an input voltage of the DC-to-DC converter. However, an output DC voltage of a DC-to-DC converter 322 may also be higher than an input voltage of the DC-to-DC converter. In an example, a DC-to-DC converter 322 has a supplied voltage (V₁) 308 in an inclusive range from 1.0 VDC through 1.6 VDC and an intermediate voltage (V₂) 306 output of 1.8 VDC.

In one example, a DC-to-DC converter 322 is coupled to a ground 106. In one embodiment, a DC-to-DC converter 322 is configured to have an efficiency over seventy percent. Use of a DC-to-DC converter 322 with an efficiency of over ninety percent is preferred. In one embodiment of the invention, a DC-to-DC converter 322 is Torex part number XC9216A20CMR that is available from Torex Corporation, located at 3 Corporate Park, Suite 270; Irvine, Calif. 92606.

An output of a DC-to-DC converter 322 is coupled to an input of a low-dropout voltage regulator 304. A voltage regulator such as a low-dropout voltage regulator 304 maintains a substantially constant output voltage when the voltage regulator's input voltage varies. The output voltage of the voltage regulator is also substantially stable for variation in loads coupled to the voltage regulator's output.

Dropout voltage is a differential voltage between a voltage input to a voltage regulator, for example intermediate voltage (V₂) 306, and a voltage output from the voltage regulator, for example output voltage (V₃) 316. The low-dropout voltage regulator 304 has a small dropout voltage relative to a dropout voltage of a typical voltage regulator 100. A dropout voltage of a low-dropout voltage regulator 304 is less than 20% of an intermediate voltage (V₂) 306 input to the low-dropout voltage regulator 304. In one example, for an input intermediate voltage (V₂) 306 voltage of 2.0 VDC, a dropout voltage is approximately 0.1 VDC. In one example, a dropout voltage is equal to or less than one-hundred millivolts. The low-dropout voltage regulator 304 also has a power supply rejection ratio (PSRR) of greater than forty decibels in example embodiments of the invention. In one example, a low-dropout voltage regulator 304 is coupled to ground 106.

In the power integration system 302 shown in FIG. 3B, a plurality of low-dropout voltage regulators are cascaded with single DC-to-DC converter 322. Specifically, the inputs of the plurality of low-dropout voltage regulators 304A-C are coupled to an output of a single DC-to-DC converter 322. The DC-to-DC converter 322 receives it's power from a power supply 302. Each low-dropout voltage regulator 304A-C provides power to it's respective load 358A-C. A load 358A-C may include, and is not limited to, a PLL 324. Accordingly, each of the low drop-out voltage regulators 304A-C can be configured to provide a different regulated voltage, so that multiple regulated output voltages can be provided on a common substrate, but in an efficient and low noise manner due to the use of the cascade configuration with the DC-to-DC converter 322.

The invention has many applications. In one example, an output of a low-dropout voltage regulator 304 is coupled to a circuit comprising a PLL 324. In another example, an output of a low-dropout voltage regulator 304 is coupled to a circuit comprising a noise-sensitive load. A noise-sensitive load is, for example, a load that provides degraded performance when powered by a noisy power supply. The invention may be part of a single-chip radio frequency circuit or a communication circuit. In other examples, a low-dropout voltage regulator 304 output supplies power to a memory circuit, a processor, a logic circuit, and/or other circuits.

The high-efficiency DC-to-DC converter 322, low-dropout voltage regulator 304, and PLL 324 may be comprised of complementary metal oxide semiconductors. The high-efficiency DC-to-DC converter 322, low-dropout voltage regulator 304, and PLL 324 may also be comprised of any combination of discrete and integrated components. In one example, the high-efficiency DC-to-DC converter 322, low-dropout voltage regulator 304, and PLL 324 are deposited on a common substrate. In addition to other benefits, deposition on a common substrate reduces manufacturing cost and saves space.

Exemplary Method of Operation

FIG. 4 illustrates a flowchart 400 that further describes operation of the invention. Flowchart 400 is further described below. The invention is described with reference to FIG. 3A, but is not limited to the example of FIG. 3A.

In step 402, an input power supply voltage is received. The input power supply voltage is typically un-regulated and is a source power supply that is desired to be converted to one or more regulated power supplies that are lower in voltage.

In step 404, an input power supply voltage is efficiently converted to an intermediate voltage. In an example, the input power supply voltage is a higher magnitude voltage than the intermediate voltage. In another example, a power supply 302 provides power to an input of the DC-to-DC converter 322. For example, a power supply 302 may be a 3.3 VDC battery. The DC-to-DC converter 322 converts the supplied voltage (V₁) 308 and supplied current (I₁) 310 to an intermediate voltage (V₂) 306 and intermediate current (I₂) 312. The intermediate voltage (V₂) 306, for example, is smaller in magnitude than the supplied voltage (V₁) 308. Excess energy is shunted to ground 106 by the DC-to-DC converter 322 in the form of I_{DCDC} 314. The efficiency of the DC-to-DC converter 322 is defined as the (V₂ 306·I₂ 312)/(V₁ 308·I₁ 310). The DC-to-DC converter 322 efficiency should be greater than eighty percent and is preferably greater than ninety percent. The output of the DC-to-DC converter 322 provides an input to the low-dropout voltage regulator 304.

In step 406, the low-dropout voltage regulator 304 regulates the output voltage (V₃) 316 at the output of the low-dropout voltage regulator 304 and shunts excess energy to ground 106 in the form of a voltage regulator current (Iᵥᵣ) 318. The output voltage (V₃) 316 is derived from the intermediate voltage (V₂) 306. For example, if the low-dropout voltage regulator 304 input intermediate voltage (V₂) 306 is 1.85 volts DC or greater, then the low-dropout voltage regulator 304 output voltage (V₃) 316 is a regulated voltage output of approximately 1.8 volts DC.

While regulating in step 406, a low-dropout voltage regulator 304 also simultaneously rejects noise present at the low-dropout voltage regulator 304 input. Part of this noise is typically present as a result of DC-to-DC converter 322 operation. For example, a low-dropout voltage regulator 304 rejects eight decibels of noise. Preferably, the low-dropout voltage regulator 304 should have a power supply rejection ratio (PSRR) of greater than thirty decibels. More preferably, a low-dropout voltage regulator 304 has a PSRR of greater than forty decibels. The low-dropout voltage regulator 304 should also reject at least five decibels of noise below 30 KHz. Preferably, a low-dropout voltage regulator 304 that rejects at least five decibels of noise below 30 KHz is used to power a PLL 324, with loop bandwidth>100 Khz to increase the response time and reduce the size of the PLL 324. Thus, the low-dropout voltage regulator 304 supplies power with a minimum amount of low frequency noise.

In an example, the low-dropout voltage regulator 304 rejects noise below a sensitive frequency of a load. The sensitive frequency of a load is a threshold frequency of noise present in the load's power supply above or below which the load's performance becomes degraded.

The low-dropout voltage regulator 304 is of a low-dropout voltage design to provide high efficiency. Use of a low-dropout voltage regulator 304 with a dropout voltage of less than one-hundred millivolts is preferred. Ideally, (V₃) 316 should equal (V₂) 306. The low-dropout voltage regulator 304 operates with high efficiency in part because the difference between voltage regulator input intermediate voltage (V₂) 306 and output voltage (V₃) 316 is small. With a large input to output voltage differential, for example when V₂ 306>>V₃ 316, a low-dropout voltage regulator 304 typically achieves low efficiency. By using a very small input to output voltage differential, a low-dropout voltage regulator 304 can achieve an efficiency greater than at least ninety percent.

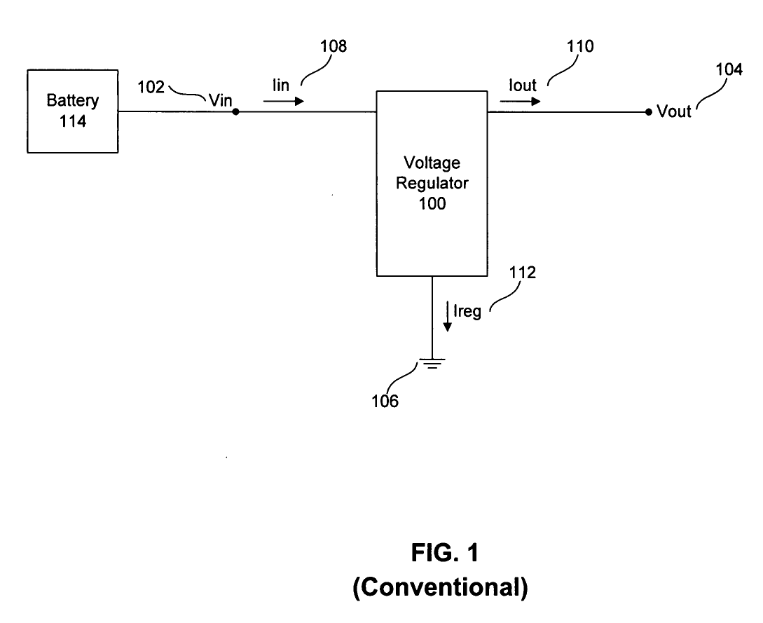

Thus, the overall efficiency of the combination of the DC-to-DC converter 322 and the low-dropout voltage regulator 304 is high because both the DC-to-DC converter 322 and the low-dropout voltage regulator 304 operate very efficiently. The combination of the DC-to-DC converter 322 and the low-dropout voltage regulator 304 also simultaneously produce a low-noise output. When low-dropout voltage regulator output current is denoted by (I₃) 320, the combined efficiency is given by: Efficiency=(V₃ 316·I₃ 320)/(V₁ 308·I₁ 310)=((V₃ 316·I₃ 320)/(V₂ 306·I₂ 312))·((V₂ 306·I₂ 312)/(V₁ 308·I₁ 310)). For example, if V₁=3.3 vdc, V₃=1.8 vdc, V₂=1.85 vdc, Ireg<<<Iout, and DC-to-DC converter 322 efficiency is 85%, then a combined efficiency of (97%)·(85%)=82.4% can be achieved. Thus, the combined efficiency in this example is an improvement over the 54.5% efficiency of the voltage regulator 100 used alone as shown in FIG. 1.

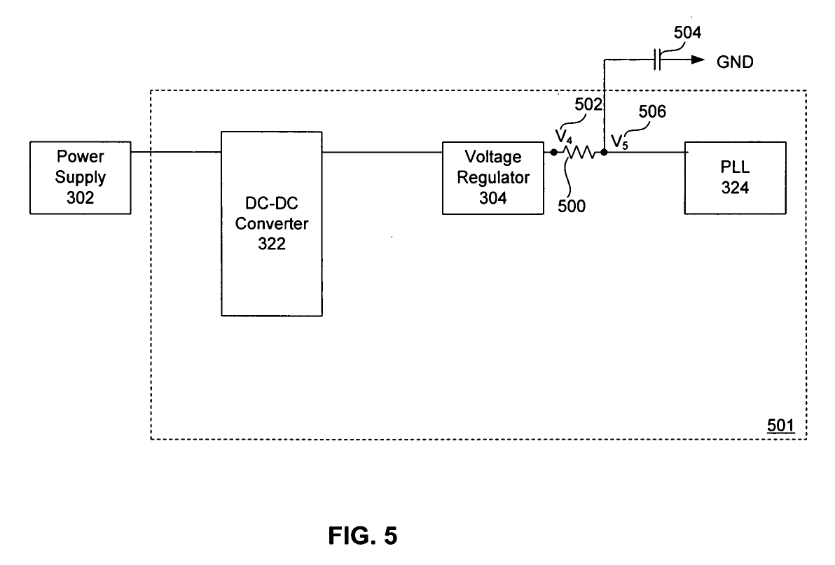

In another embodiment shown in FIG. 5, the DC-DC converter 322, the low-dropout voltage regulator 304, and the PLL 324 are deposited on a common substrate 501. This embodiment provides a low pass filter that further rejects noise at frequencies >10 KHz when additional high frequency noise rejection beyond that provided by the voltage regulator 304 is required. A resistor 500 is added to the circuit in series with an output of the low dropout voltage regulator 304A between node (V₄) 502 and node (V₅) 506. The node (V₅) 502 is coupled to a capacitor 504. In an example, the resistor 500 has a resistance of ˜10 ohms and the capacitor 504 has a capacitance of ˜10 μF. The output voltage of the regulator, (V₄) 502 is adjusted to account for a voltage drop thru the resistor 500, to give the required (V₅) 506. For example if the PLL 202 requires 5 mA then (V₄) 502 is increased by 5 mA*10 ohms=50 mV. In another example, the capacitor 504 is coupled to the node (V₅) 506 via a conductive interface such as, and not limited to, a pin, a ball grid array, a lead, and/or a tab.

Power from the low-dropout voltage regulator 304 can be supplied to many different types of loads including but not limited to PLLs 324, oscillators, memory circuits, processors, audio codecs, and other circuits. Other applications include but are not limited to powering transmitters, receivers, transceivers, and telecommunication headsets.

Conclusion

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

It is to be appreciated that the Detailed Description section, and not the Summary or Abstract sections, is intended to be used to interpret the claims. The Summary and Abstract sections may set forth one or more but not all exemplary embodiments of the present invention as contemplated by the inventor(s), and thus are not intended to limit the present invention and the appended claims in any way.

What is claimed is:

1. A integrated circuit power supply, comprising:
a voltage supply input;
a direct-current to direct-current (DC-to-DC) converter, configured to convert said voltage supply input to an intermediate voltage that is lower than said voltage supply input; and
a voltage regulator, coupled to an output of said DC-to-DC converter, wherein said voltage regulator has a low dropout voltage and provides a regulated output voltage.

2. The integrated circuit power supply of claim 1, wherein said regulated output voltage provides a power supply to at least one of a phase locked loop circuit and a noise-sensitive electrical load.

3. The integrated circuit power supply of claim 1, wherein said voltage supply input, said DC-to-DC converter, and said voltage regulator are disposed on a common substrate.

4. The integrated circuit power supply of claim 1, wherein the voltage regulator rejects noise below a sensitive frequency of a load.

5. The integrated circuit power supply of claim 1, wherein at least one of the DC-to-DC converter and the voltage regulator are comprised of complementary metal oxide semiconductors.

6. The integrated circuit power supply of claim 1, wherein said voltage regulator is one of a plurality of voltage regulators, each voltage regulator in the plurality of voltage regulators having an input coupled to an output said DC-to-DC converter.

7. The integrated circuit power supply of claim 1, wherein said DC-to-DC converter has an efficiency of at least 80%.

8. The integrated circuit power supply of claim 1, wherein said low drop-out regulator has an efficiency of at least 90%.

9. A method of providing on-chip power for an integrated circuit, comprising:
receiving an input voltage;
converting said input voltage to an intermediate voltage; and
regulating an output voltage derived from said intermediate voltage while simultaneously rejecting noise during said step of regulating.
